(19) United States
(12) Patent Application Publication
(10) Pub. No.: US 2006/0228106 A1
(43) Pub. Date: Oct. 12, 2006

(54) Security apparatus and autonomous cleaner

(75) Inventor: Ryo Saeki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/284,956

(22) Filed: Nov. 22, 2005

(30) Foreign Application Priority Data
Nov. 22, 2004 (JP) 2004-338118

(51) Int. Cl. G03B 17/00

(52) U.S. Cl. 396/427

(57) ABSTRACT

A security device provided with a human body detecting unit for detecting a man to monitor an intruder from the outside, includes: a direction specifying unit for specifying the direction in which the man detected by the human body detecting unit accesses; a direction determining unit for determining whether or not the direction specified by the direction specifying unit agrees a preset direction; and a reporting unit for making a report if the direction determining unit determines that the direction specified by the direction specifying unit does not agree with the preset direction.

### BACKGROUND OF THE INVENTION

1. Field of the Invention

This invention relates to a security device and a autonomous (self-propelled) cleaner provided with the security device.

2. Description of the Related Art

Traditionally, as a human body sensor for detecting a man, infrared rays and others have been employed. And an electric cleaner has been developed which free runs upon distance from the man through the human body sensor using infrared rays (JP-A-2-007930).

Further, the human body sensor is applied to security devices and others. Of these security devices, there is a previously known security device installed at e.g. a front door which changes from a security mode to a security releasing mode through a button operation within a predetermined time (JP-A-2002-279564).

Another security device is also known in which the change from the security mode to the security releasing mode is made by checking a personal identification number (JP-A-5-197886)

### SUMMARY OF THE INVENTION

The security devices disclosed in JP-A-2002-279564 and JP-A-5-197886 can not determine whether or not a man at issue is a family member or an intruder until security release is made, but detects the man as the intruder even if he or she is the family member until the security mode is released. Therefore if a predetermined time elapses from when the family member forgets to release the security mode, the man is recognized as the intruder, which will be reported. In addition, since the condition for security release is only the button operation or checking of the personal identification number, the conventional security devices cannot deal with the case where the intruder has previously gotten the personal identification number, and so give low security.

An object of this invention is to provide a security device capable of preventing a family member from being misidentified as an intruder.

According to a first aspect of the invention, there is provided a security device provided with a human body detecting unit for detecting a man to monitor an intruder from the outside, including: a direction specifying unit for specifying the direction in which the man detected by the human body detecting unit accesses; a direction information storing unit for storing the direction preset by a user; a direction determining unit for determining whether or not the direction specified by the direction specifying unit agrees with the direction stored in the direction information storing unit; a reporting unit for making a report if the direction determining unit determines that the direction specified by the direction specifying unit does not agree with the direction stored in the direction information storing unit; an inputting unit for inputting release information for monitor releasing; a determining unit for determining whether or not the release information inputted by the inputting unit is right; a releasing unit for releasing the monitoring if the direction determining unit determines that the direction specified by the direction specifying unit agrees with the direction stored in the direction information storing unit and if the determining unit determines that the release information inputted by the input unit is right; and a monitor release operating unit for carrying out a predetermined operation indicative of that the monitoring has been released if the determining unit determines that the release information inputted by the inputting unit is right.

According to a second aspect of the invention, there is provided a security device provided with a human body detecting unit for detecting a man to monitor an intruder from the outside, including: a direction specifying unit for specifying the direction in which the man detected by the human body detecting unit accesses; a direction determining unit for determining whether or not the direction specified by the direction specifying unit agrees a preset direction; and a reporting unit for making a report if the direction determining unit determines that the direction specified by the direction specifying unit does not agree with the preset direction.

According to a third aspect of the invention, there is provided a security device according to the second aspect of the invention, further including: an inputting unit for inputting release information for monitor releasing; a determining unit for determining whether or not the release information inputted by the input unit is right; and a releasing unit for releasing the monitoring if the direction determining unit determines that the direction specified by the direction specifying unit agrees with the preset direction and if the determining unit determines that the release information inputted by the input unit is right.

According to a fourth aspect of the invention, there is provided a security device according to the third aspect of the invention, further including: a monitor release operating unit for carrying out a predetermined operation indicative of that the monitoring has been released if the releasing unit releases the monitoring.

According to a fifth aspect of the invention, there is provided a autonomous cleaner provided with a security device according any one of the first to fourth aspects of the invention.

In the first aspect of the invention, the direction specifying unit specifies the direction in which the man detected by the human body detecting unit accesses; the direction determining unit determines whether or not the direction specified by the direction specifying unit agrees with the direction preset by a user and stored in a direction information storing unit; the reporting unit makes a report if the direction determining unit determines that they do not agree with each other; the releasing unit releases the monitoring if the direction determining unit determines that they agree with each other and if the determining unit determines that the release information inputted by the inputting unit is right; and the monitor release operating unit carries out a predetermined operation indicative of that the monitoring has been released if the determining unit determines that the release information inputted by the input unit is right. In accordance with such a configuration, a family member can be discriminated from an intruder by the direction in which the man accesses, detected by the human body detecting unit, thereby preventing the family member from being misidentified as the intruder.

Further, even when the intruder accidentally accesses from the direction in agreement with the direction stored in the direction information storing unit, the monitoring is not released unless the determining unit does not determine that the release information is right. Thus, the security device with great security can be provided.

Further, if it is determined that the direction in which the man detected by the human body detecting unit accesses agrees with the direction stored in the direction information storing unit and if the determining unit determines that the inputted release information is right, the release unit releases the monitoring and the monitor release operating unit carries out a predetermined operation indicative of that the monitoring has been released. In accordance with such a configuration, whether or not the monitoring has been released can be easily confirmed.

Further, since the direction stored in the direction information storing unit is preset by a user, the direction the user desires can be set, thereby providing improved operability.

In the second aspect of the invention, the direction specifying unit specifies the direction in which the man detected by the human body detecting unit accesses; the direction determining unit determines whether or not the direction specified by the direction specifying unit agrees with a preset direction; and the reporting unit makes a report if the direction determining unit determines that they do not agree with each other. In accordance with such a configuration, a family member can be discriminated from an intruder, thereby preventing the family member from being misidentified as the intruder.

It is needless to say that the third aspect of the invention gives the same advantage as the second aspect of the invention. In addition, in the third aspect of the invention, if the direction determining unit determines that the direction specified by the direction specifying unit agrees with the preset direction and if the determining unit determines that the release information inputted by the inputting unit is right, the releasing unit releases the monitoring. In accordance with such a configuration, even when the intruder accidentally accesses from the direction in agreement with the direction stored in the direction information storing unit, the monitoring is not released unless the determining unit does not determine that the release information is right. Thus, the security device with great security can be provided.

It is needless to say that the fourth aspect of the invention gives the same advantage as the third aspect of the invention. In addition, in the fourth aspect of the invention, particularly if the releasing unit releases the monitoring as a result that the direction determining unit determines that the direction specified by the direction specifying unit agrees with the preset direction and the determining unit determines that the release information inputted by the inputting unit is right, the monitor release operating unit carries out a predetermined operation indicative of that the monitoring has been released. Thus, the user can easily confirm whether or not the monitoring has been released.

It is needless to say that the fifth aspect of the invention gives the same advantage as the invention according to any one of the first to fourth aspects of the invention. Particularly, since the autonomous cleaner of the fifth aspect of the invention is provided with the security device, the autonomous cleaner with an added value can be provided.

### BRIEF DESCRIPTION OF THE DRAWINGS

These and other objects and advantages of this invention will become more fully apparent from the following detailed description taken with the accompanying drawings in which:

FIG. 1 is a side view of an autonomous cleaner provided with the security function according to this invention;

FIG. 2 is a plan view of an autonomous cleaner provided with the security function according to this invention;

FIG. 3 is a front view of an autonomous cleaner provided with the security function according to this invention;

FIG. 4 is a block diagram showing the construction of an autonomous cleaner provided with the security function according to this invention;

FIG. 5 is a plan view of the input section of an autonomous cleaner provided with the security function according to this invention;

FIG. 6 is a front view of the arrangement of light emitting diodes on a substrate in an autonomous cleaner provided with the security function according to this invention;

FIG. 7 is a block diagram of the arrangement of the storage unit in an autonomous cleaner provided with the security function according to this invention;

FIG. 8 is a graph showing a spectral reflectance;

FIG. 9 is a flowchart showing the operation in a security mode in an autonomous cleaner provided with the security function according to this invention; and

FIG. 10 is a flowchart of the flow of human body detecting processing in an autonomous cleaner provided with the security function according to this invention.

### DETAILED DESCRIPTION OF THE PREFERRED EMBODIMENTS

Now referring to the drawings, a detailed explanation will be given of an best mode or embodiment for carrying out the security device according to this invention. Incidentally, in this embodiment, an explanation will be given of a typical example of a security device 8 attached to a autonomous cleaner 100.

Construction of the Autonomous Cleaner and the Security Device

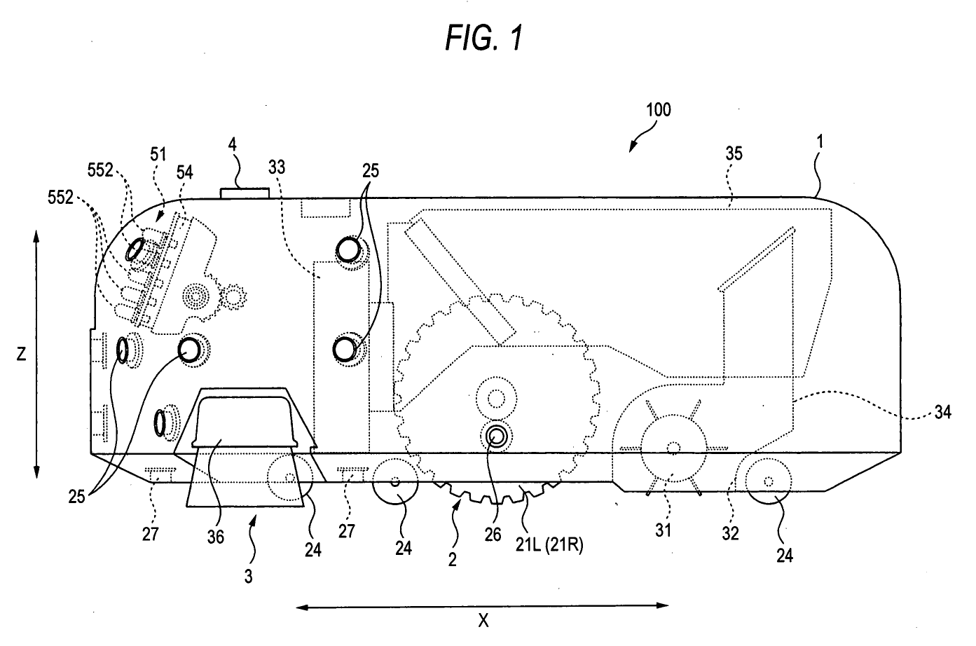

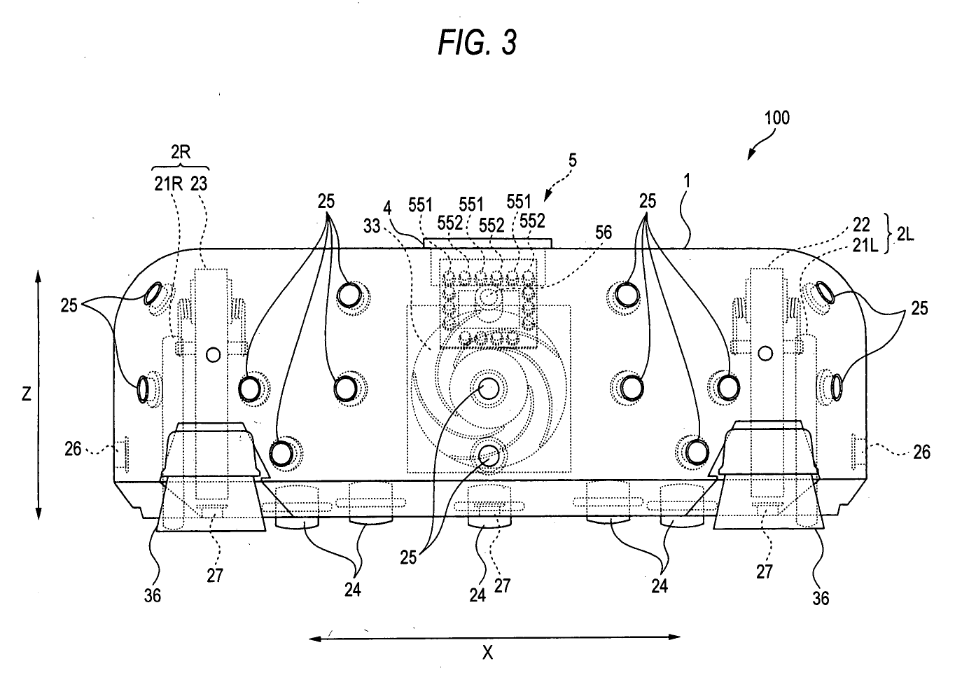

The autonomous cleaner 100 serves to autonomously run on the basis of a predetermined running pattern within a room, thereby carrying out cleaning. The autonomous cleaner 100, as seen from FIGS. 1 to 4, includes a cabinet 1 formed in a cylindrical shape and closed in the upper face, a running section 2 which is located within the cabinet 1 and moves the autonomous cleaner 100 in a desired direction, a cleaning section 3 for cleaning the dust on a cleaning plane which is a running plane during movement, an input section 4 from which a designating operation by a user can be done, a human body detecting device 5 for detecting a man or men present in the environment, a control section 6 for controlling operations of each of them and a communication section 7.

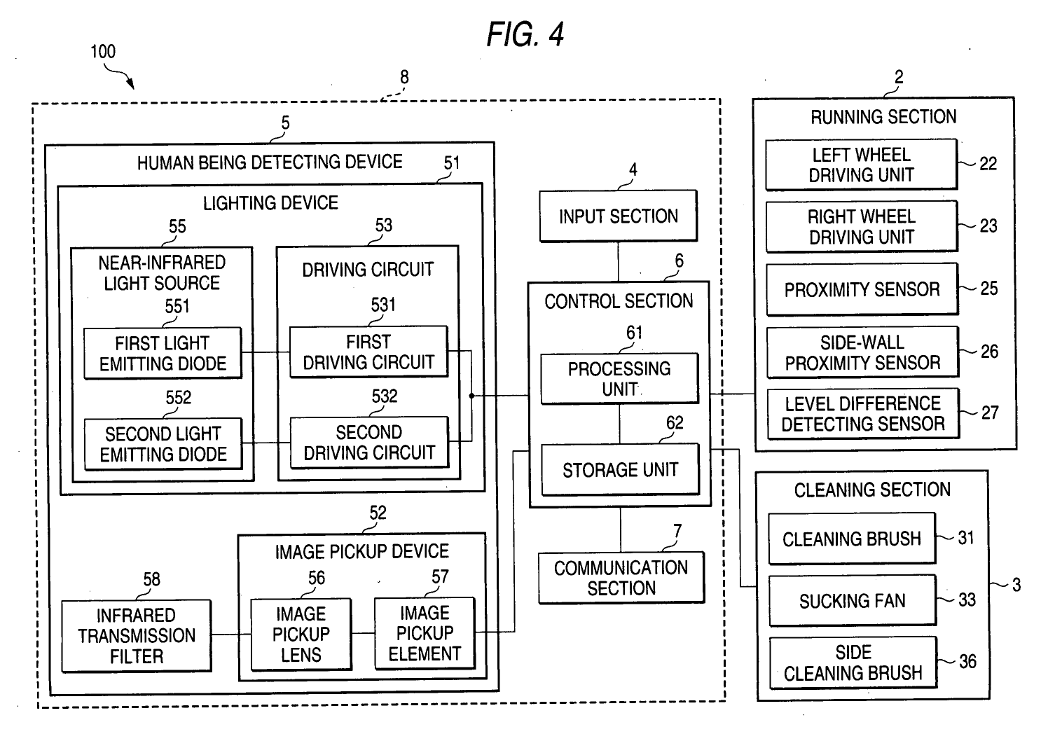

And as seen from FIG. 4, the security device 8 is constructed of the input section 4, human body detecting device 5, control section 6, communication section 7, etc.

Cabinet

The cabinet 1 serves to protect the running section 2, control section 6, etc. from extraneous shock and dust. The cabinet 1 is provided to cover their top and side.

In the cabinet 1, the area which covers a lighting device 51 of the human body detecting device 5 is transparent. So light emitted from the lighting device 51 can pass through the area.

Running Section

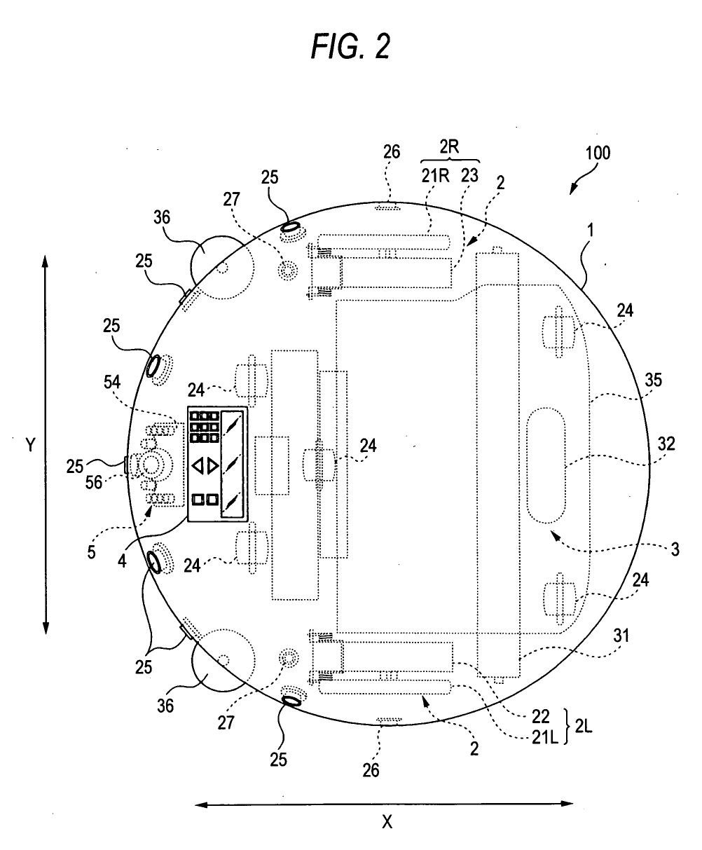

The running section 2 includes two driving wheels 21L, 21R arranged at the ends on both left and right sides in a nearly central running direction on the bottom of the autonomous cleaner 100; a left wheel driving portion 22 and a right wheel driving portion 23 for independently rotation-driving these driving wheels 21L, 21R; a predetermined number (five in FIG. 2) of follower wheels 24 which rotate to follow the running of the autonomous cleaner 100; a proximity sensor 25 for measuring the distance to an obstacle such as a wall or furniture residing in a running direction, side-wall proximity sensors 26, 26 for measuring the distance to the obstacle such as side walls residing in a lateral direction Y of the autonomous cleaner 100 and a level difference detecting sensor 27 for detecting a level difference such as an uneven spot residing on the running plane.

Cleaning Section

The cleaning section 3 includes a cleaning brush 31 for raking up dust on the cleaning plane (running plane), a sucking fan 33 which is driven to collect the dust on the cleaning plane through a sucking mouth 32, a dust-collecting section 35 communicated with the sucking mouth 32 through a communicating portion 34 and collecting the dust sucked through the sucking section 32, and a side cleaning brush 36 for cleaning the cleaning plane outside the cleaning brush 31.

Input Section

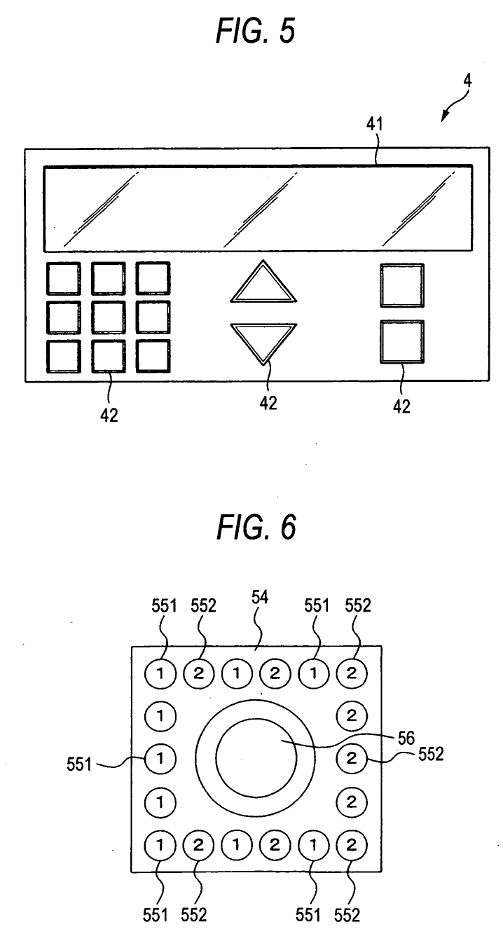

The input section 4, as seen from FIG. 5, includes a liquid crystal display area 41 for displaying various inputting states and others, a plurality of input keys 42 for inputting the instruction such as execution of various functions of the autonomous cleaner 100 and the direction in which the user accesses the autonomous cleaner 100 in the security mode, etc. The input section 4 serves as an inputting unit for supplying the input signal inputted by the user to the control section 6.

Human Body Detecting Device

The human body detecting device 5 is a device for detecting a human body, which picks up the situation of a room in which the autonomous cleaner 100 is placed and detects whether or not the image picked up includes a skin, and serves as a part of a human body detecting unit. The human body detecting device 5, as seen from FIGS. 1 to 4, includes the lighting device 51 having a near-infrared light source 55 emitting near-infrared rays with different wavelengths and an image pick-up device 52 for picking up an object.

The lighting device 51, as seen from FIGS. 1 to 4, includes a driving circuit 53 connected to the control section 6, a substrate 54 connected to the driving circuit 53 and plural kinds of near-infrared light sources 55 with different wavelengths integrally held on the substrate 54.

The near-infrared light sources 55 are e.g. light emitting diodes inclusive of two kinds of a first light-emitting diode 551 with a light emitting wavelength shorter than 900 nm and a second light-emitting diode 552 with a central light emitting wavelength of 900 nm to 1000 nm. A plurality of light emitting diodes each is provided for each kind of light emitting diode.

As seen from FIG. 6, the respective light emitting diodes 551, 552 are repetitively arranged in the order of the first light emitting diode 551 and the second light emitting diode 552 in the lateral direction of the substrate 54. Except the area where the image pick-up device 52 is placed, this arrangement is repeated in a longitudinal direction.

The driving circuit 53 includes a first driving circuit 531 for supplying a current to light the first light emitting diode 551 by a control signal from the control section 6 and a second driving circuit 532 for supplying a current to light the second light emitting diode 552 by a control signal from the control section 6. Namely, the driving circuit 53 is provided for each kind of light emitting diode. Thus, the light emitting diodes which emit light with the same wavelength are simultaneously lighted by the control signal form the control section 6.

The image pick-up device 52, as seen from FIG. 4, includes an image pick-up lens 56 for converging the light reflected when the light emitted from the near-infrared light source 55 impinges on the object so that an object image is imaged, and an image pick-up element 57 with a light-receiving sensitivity in the near infrared range for creating an object picture on the basis of the object image imaged by the image pick-up lens 56.

The image pick-up lens 56 is located to image the image on the light receiving plane of the image pick-up element 57. The image pick-up lens 56 is constructed of a single body of a convex lens or concave lens and a combination thereof.

The image pick-up element 57 is constructed of a CCD (Charge Coupled Device), CMOS (Complementary Metal Oxide Semiconductor), etc. which picks up the range to be picked up ahead of the image pick-up lens 56 under the control by the control section 6. More specifically, the imaged image inputted from the image pick-up lens 56 is converted into an electric signal by the CMOS and others, the image data is created as a digital signal by an A/D converter circuit and the image thus created is supplied to the control section 6.

Further, the human body detecting device 5 is provided with an infrared transmission filter 58. The infrared transmission filter 58 serves to interrupt the light with a wavelength called visible light and transmit only the near infrared ray. This is because the transmission filter 58 intends to remove the light from a fluorescent lamp within a room to enhance the detecting accuracy for a man.

Control Section

The control section 6 includes a processing unit 61 for carrying out various kinds of processing and a storage unit 62 which is used as a working area for the processing unit 61 and stores a system program necessary to control the respective parts of the processing unit 61.

The processing unit 61 is constructed of e.g. a CPU. The processing unit 61 reads and develops the program stored in the storage unit 62, and on the basis of the program, makes control on instructions to the respective parts and transmission/reception of data.

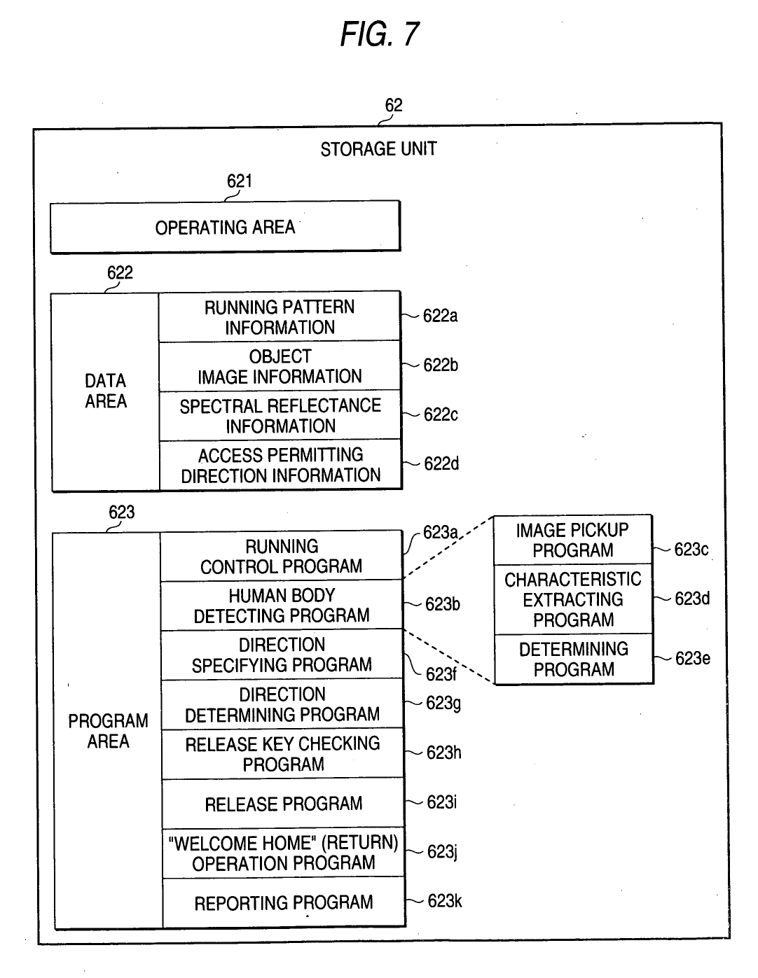

As seen from FIG. 7, the storage unit 62 is constructed of a RAM or ROM, and includes an operating area 621 serving as a working area for the processing unit 61, a data area 622 which stores object image information 622b created by the image pick-up element 57, spectral reflectance information 622c and access permitting information 622d preset by a user, etc. and a program area 623 which stores a program to be executed by the processing unit 61.

The data area 622 also stores running pattern information 622a relative to a predetermined running pattern of the autonomous cleaner 100 previously installed. For example, the running pattern sequentially repeats the running in which by rotation-driving the two driving wheels 21L, 21R at approximately equal speeds, the autonomous cleaner 100 runs straight ahead in a predetermined direction; and during the running, when it detects the obstacle in the running direction on the basis of an output signal from the proximity sensor 25 it stops to run and makes a U-turn, i.e. turns 180° and thereafter runs ahead forward toward the direction opposite to the predetermined direction.

Incidentally, the running pattern information 622a may be set on the basis of a predetermined operation for the input section 4 by the user, or may be previously set as a default in the stage of manufacture/shipping.

Further, the data area 622 stores the object image information 622b on the image picked up by the image pick-up device 52.

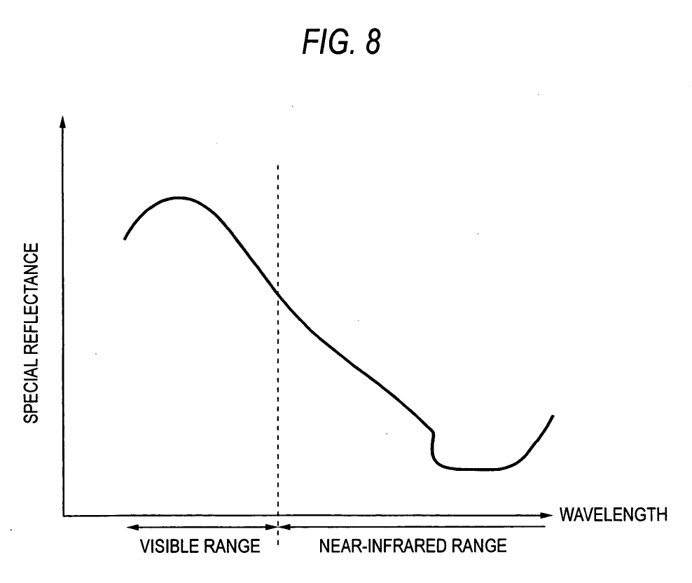

Further, the data area 622 stores, as shown in FIG. 8, the spectral reflectance 622c which correlates the wavelength of the near infrared ray with the spectral reflectance of the skin of a man.

Further, the data area 622 stores the access permitting direction information 622d preset by the user which serves as a direction information storing unit. In this embodiment, the access permitting direction information 622d is preset by the user, but may be set as the default.

The program area 623 stores e.g. a running control program 623a, a human body detecting program 623b, an image pick-up program 623c, a characteristic extracting program 623d, a determining program 623e, a direction specifying program 623f, a direction determining program 623g, a release key checking program 623h, a release program 623i, a “welcome home” (return) operation program 623j, a reporting program 623k, etc.

The running control program 623a is e.g. a program for causing the control section 6 to realize the function of controlling the running of the autonomous cleaner 100 on the basis of the running pattern information 622a. More specifically, this program causes the control section 6 to control the driving wheels 21L, 21R of the autonomous cleaner 100 so that the autonomous cleaner 100 makes cleaning while avoiding the obstacle in the running direction, etc. on the basis of the running pattern information 622a.

The human body detecting program 623b is e.g. a program for causing the control section 6 to realize the function of detecting whether or not the object image stored in the storage unit 62 includes the skin picked up. Now, since the processing unit 61 executes the human body detecting program 623b, the control section 6 serves as a part of the human body detecting unit. The human body detecting program 623b includes at least the image pick-up program 623c, characteristic extracting program 623d and determining program 623e.

The image pick-up program 623c is e.g. a program for causing the control section 6 to realize the function of controlling the first driving circuit 531 and second driving circuit 532 so that a current is supplied to the first light emitting diode 551 and second light emitting diode 552 to emit light, and of controlling the image pick-up element 57 so that the light reflected from the object is converged through the image pickup lens 56 and the image thus created is converted into an electric signal which is supplied to the control section 6 as a digital signal.

The characteristic extracting program 623d is e.g. a program for causing the control section 6 to realize the function of extracting the magnitude relationship between the pixel values in the object images picked up according to the near infrared rays (two kinds) with the wavelengths, stored in the data area 622. The relationship between the pixel values may be e.g. difference between the pixel values, a change in the pixel value (gradient) corresponding to the change in the wavelength, etc.

The determining program 623e is e.g. a program for causing the control section 6 to compare the magnitude relationship between the pixel values, extracted when the processing unit 61 executes the characteristic extracting program 623d, with the spectral reflectance information 622c stored in the data area 622 of the storage unit 62 thereby to determine whether or not the pixel at a predetermined position represents the skin picked up. More specifically, the control section 6 compares the magnitude relationship between the pixel values with the spectral reflectance information 622c and if they are approximate to each other within a permissible range, determines that the pertinent pixel is a candidate for the skin corresponding region and if the candidate pixel occupies a predetermined region, determines that the region represents the skin picked up.

The direction specifying program 623f is e.g. a program for causing the control section 6 to realize the function of specifying the direction in which the man accesses the autonomous cleaner 100 on the basis of the movement of the skin region detected by executing the human body detecting program 623b in the objected images successively picked up. Since the processing unit 61 executes the direction specifying program 623f, the control section 6 serves as the direction specifying unit.

The direction determining program 623g is e.g. a program for causing the control section 6 to realize the function of determining whether or not the direction specified by executing the direction specifying program 623f agrees with the direction preset by the user and stored in the access permitting direction information 622d. Since the processing unit 61 executes the direction determining program 623g, the control section 6 serves as the direction determining unit.

The release key checking program 623h is e.g. a program for causing the control section 6 to realize the function of determining whether or not the release key as the release information inputted from the input section 4 agrees with a preset release key. Since the processing unit 61 executes the release key checking program 623h, the control section 6 serves as the determining unit.

The release program 623i is e.g. a program for causing the control section 6 to realize the function of releasing the monitoring if it is determined by executing the direction determining program 623g that the direction specified by executing the direction specifying program 623f agrees with the direction preset by the user and also if it is determined by executing the release key checking program 623h that the release information inputted from the input section 4 is right. Since the processing unit 61 executes the release program 623i, the control section 6 serves as the release unit.

The “welcome home” (return) operation program 623j is e.g. a program for causing the control section 6 to realize the function of causing the autonomous cleaner 100 to carry out a predetermined operation indicative of the monitoring has been released if it is determined by executing the release key checking program 623h that the release key inputted from the input section 4 is right and if the monitoring has been released by executing the release program 623i. More specifically, the control section 6 causes the autonomous cleaner 100 to carry out the “welcome home” (return) operation when the monitoring is released. The “welcome home” (return) operation is e.g. an operation such as the autonomous cleaner 100 turns round and round; the liquid crystal display area 41 is lit; a message on the liquid crystal display area 41 is displayed, etc. Since the processing unit 61 executes the “welcome home” (return) operation program 623j, the control section 6 serves as the monitoring release operating unit.

The reporting program 623k is e.g. a program for causing the control section 6 to realize the function of controlling the communication section 7 to make a report. More specifically, the control section 6 controls the communication section 7 to make a report if it is determined by executing the direction determining program 623g that the direction specified by executing the direction specifying program 623f does not agree with the direction stored in the access permitting direction information 622d, or determined by executing the release key checking program 623h that the release key inputted is not right. Since the processing unit 61 executes the reporting program 623k, the control section 6 serves as a part of the reporting unit.

Communication Section

The communication section 7 is constructed of a modem (MODEM: Modulator/Demodulator), terminal adapter, LAN adapter, etc. The communication section 7 carries out communication with an external device (not shown) through a network (not shown). More specifically, the communication section 7 is controlled by the control section 6 to execute the reporting program 623k, thereby making a report to the external device (e.g. cellular phone of a family member and terminal device of a security company) and serves as a part of the reporting unit.

Operation in the Security Mode

Next, an explanation will be given of the operation of the security device 8 in the security mode of the autonomous cleaner 100 having the configuration as described above.

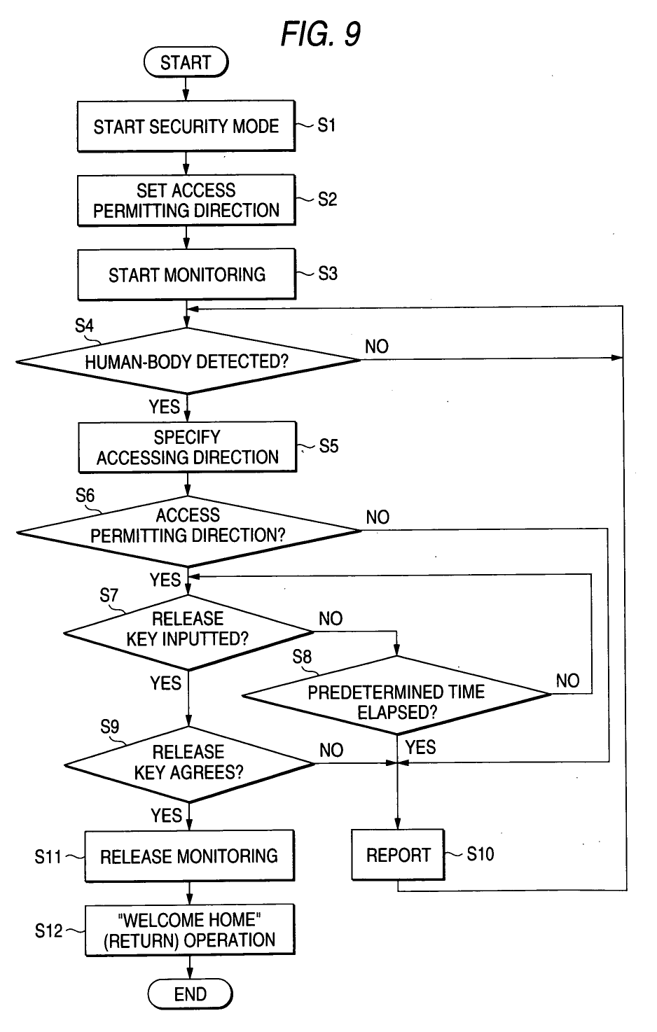

As seen from FIG. 9, when the security mode is selected through the input section 4 by the user, the security mode is started (step S1). Next, the access permitting direction information 622d is inputted through the input section 4 to the control section 6 by the user and stored in the data area 622 of the storage unit 62 (step S2). Then, the monitoring is started (step S3).

Next, the processing unit 61 executes the human body detecting program 623b to control the human body detecting device 5, thereby detecting a man (step S4).

In step S4, if no man is detected (step S4; No), the processing in step S4 is repeated until any man is detected.

In step S4, if a man is detected (step S4; Yes), the processing proceeds to step S5.

Next, the processing unit 61 executes the direction specifying program 623f to specify the direction in which the man accesses the autonomous cleaner 100 on the basis of the movement of the skin region detected by executing the human body detecting program 623b in the object images successively picked up (step S5).

Next, the processing unit 61 executes the direction determining program 623g to determine whether or not the direction specified in step S5 agrees with the direction preset by the user, and stored in the access permitting direction information 622d (step S6).

If it is determined in step S6 that the direction specified in step S5 does not agree with the direction stored in the access permitting direction information 622d (step S6; No), the processing proceeds to step S10 to make a report to the external device (e.g. cellular phone of a family member and terminal device of a security company) through the communication section 7.

If it is determined in step S6 that the direction specified in step S5 agrees with the direction stored in the access permitting direction information 622d (step S6; Yes), the processing proceeds to step S7.

Next, the processing unit 61 executes the release key checking program 623h to determine whether or not the release key has been inputted from the input section 4 (step S7).

If it is determined in step S7 that the release key has not been inputted (step S7; No), the processing proceeds to step S8 to determine whether or not a predetermined time has elapsed.

If it is determined in step S8 that the predetermined time has not elapsed (step S8; No), the processing in steps S7, S8 is repeated until the predetermined time elapses.

If it is determined in step S8 that the predetermined time has elapsed (step S8; Yes), the processing proceeds to step S10 to make a report to the external device through the communication section 7.

If it is determined in step S7 that the release key has been inputted (step S7; Yes), it is determined whether or not the release key inputted from the input section 4 agrees with a preset release key (step S9).

If it is determined in step S9 that the inputted release key does not agree with the preset release key (step S9; No), the processing proceeds to step S10 to make a report to the external device.

If it is determined in step S9 that the inputted release key agrees with the preset release key (step S9; Yes), the processing proceeds to step S11.

Next, the processing unit 61 executes the release program 623i to release the monitoring by the autonomous cleaner 100 (step S11).

Next, the processing unit 61 executes the “welcome home” (return) operation to cause the autonomous cleaner 100 to carry out the “welcome home” (return) operation program 623j, thereby indicating that the monitoring has been released (step S12). The “welcome home” (return) operation may be any operation such as the autonomous cleaner 100 turns round and round; the liquid crystal display area 41 is lit, or a message on the liquid crystal display area 41 is displayed.

Man Detecting Processing

Next, a detailed explanation will be given of the man detecting processing by the human body detecting device 5 in step S4.

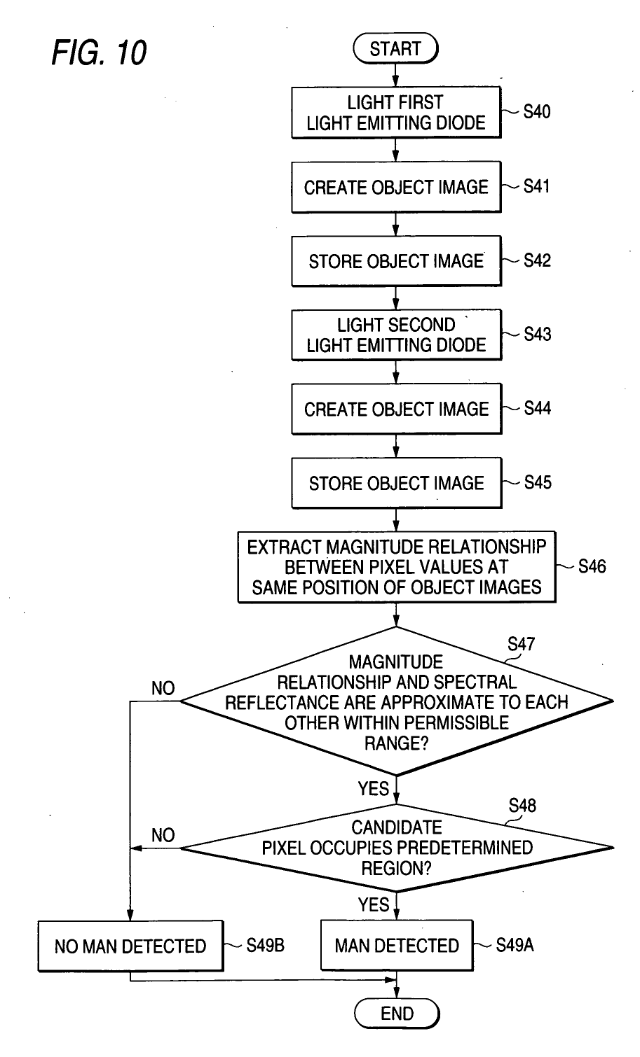

As seen from FIG. 10, the processing unit 61 executes the image pickup program 623c to control the first driving circuit 531 so that a current is supplied to the first light emitting diode 551 to emit light, thereby illuminating the object (step S40).

Next, the reflected light from the object and visible light, after having passed through the infrared transmission filter 58, are converged by the image pickup lens 56 to reach the image pickup element 57, thereby forming an object image (step S41). When the reflected light from the object and visible light pass through the infrared transmission filter 58, only the near infrared light is transmitted and the visible light is not transmitted. Next, the pertinent object image is stored in the data area 622 of the storage unit 62 (step S42).

Next, the processing unit 61 executes the image pickup program 623c to control the first driving circuit 531 so that the current supply to the first driving circuit 551 is stopped and to control the second driving circuit 552 so that a current is supplied to the second light emitting diode 552 to emit light, thereby illuminating the object (step S43).

Next, the reflected light from the object and visible light, after having passed through the infrared transmission filter 58, are converged by the image pickup lens 56 to reach the image pickup element 57, thereby forming an object image (step S44). Next, the pertinent object image is stored in the data area 622 of the storage unit 62 (step S45). The processing unit 61 controls the second driving circuit 532 so that the current supply to the second light emitting diode 552 is stopped, thereby stopping light emission of the second light emitting diode 552.

Next, the processing unit 61 executes the characteristic extracting program 623d to extract the magnitude relationship between the pixel values at the same position in the object images picked up according to the near infrared rays with the wavelengths, stored in the data area 622 (step S46).

Next, the processing unit 61 execute the determining program 623e to compare the magnitude relationship between the pixel values, extracted in step S46, with the spectral reflectance information 622c stored in the data area 622 of the storage unit 62 thereby to determine whether or not they are approximate to each other within a permissible range (step S47).

If it is determined in step S47 that the magnitude relation ship between the pixel values in the object image and the spectral reflectance information 622c are not approximate to each other within the permissible range (step S47; No), the processing proceeds to step S49B in which it is determined that no man is detected.

If it is determined in step S47 that the magnitude relation ship between the pixel values in the object image and the spectral reflectance information 622c are approximate to each other within the permissible range (step S47; Yes), the pertinent pixel is taken as the candidate for a skin corresponding region. And it is determined whether or not the candidate pixel occupies a predetermined region (step S48).

If it is determined in step S48 that the candidate pixel occupies the predetermined region (step S48; Yes), the processing proceeds to step S49A in which any man has been detected.

If it is determined in step S48 that the candidate pixel does not occupy the predetermined region (step S48, No), the processing proceeds to step S49B in which no man is has been detected.

In accordance with the autonomous cleaner 100 according to this embodiment hitherto described, the control section 6 executes the direction specifying program 623f to specify the direction in which the man accesses, detected by executing the human body detecting program 623b; and executes the direction determining program 623g to determine whether or not the specified direction agrees with the direction preset by the user and stored in the access permitting direction information 622d and if it is determined that the former does not agree with the latter, executes the reporting program 623k to make a report to the external device. For this reason, the family member and intruder can be discriminated from each other by the direction in which the man accesses, detected by executing the human body detecting program 623b, a family member can be discriminated from an intruder, thereby preventing the family member from being misidentified as the intruder.

Further, if it is determined by executing the direction determining program 623g that the direction specified by executing the direction specifying program 623f agrees with the direction stored in the access permitting direction information 622d and determined by executing the release key checking program 623h that the release key inputted from the input section 4 is right, the control section 6 executes the release program 623i to release the monitoring. For this reason, even when the intruder accidentally accesses from the direction in agreement with the direction stored in the access permitting direction information 622d, the monitoring is not released unless it is determined that the release key is right. Thus, the autonomous cleaner 100 provided with the security device with great security can be provided.

Further, if it is determined by executing the release key checking program 623h that the inputted release key is right and so the monitoring is released by executing the release program 623i, the control section 6 executes the “welcome home” (return) operation program 623j to carry out a predetermined operation indicative of that the monitoring has been released. So the user can easily confirm whether or not the monitoring has been released.

Further, since the direction stored in the access permitting direction information 622d is preset by the user, the user can set direction he desires, thereby providing improved operability.

Since the autonomous cleaner 100 is provided with the security device, the autonomous cleaner 100 with an added value can be provided.

Incidentally, as the embodiment of this invention, the security device installed in the autonomous cleaner has been exemplified. However, this invention can be applied to the security device installed in the other electronic device such as a telephone set. Further, the security device according to this invention is not necessarily required to be installed in the electronic device. For example, this invention can be applied to a warning device installed at the front door.

Further, a voice output section may be provided to carry out the “welcome home” (return) by emitting sound.

What is claimed is:

1. A security device provided with a human body detecting unit for detecting a man to monitor an intruder from the outside, comprising:
a direction specifying unit for specifying the direction in which the man detected by the human body detecting unit accesses;
a direction information storing unit for storing the direction preset by a user;
a direction determining unit for determining whether or not the direction specified by the direction specifying unit agrees with the direction stored in the direction information storing unit;
a reporting unit for making a report if the direction determining unit determines that the direction specified by the direction specifying unit does not agree with the direction stored in the direction information storing unit;
an inputting unit for inputting release information for monitor releasing;
a determining unit for determining whether or not the release information inputted by the inputting unit is right;
a releasing unit for releasing the monitoring if the direction determining unit determines that the direction specified by the direction specifying unit agrees with the direction stored in the direction information storing unit and if the determining unit determines that the release information inputted by the input unit is right; and
a monitor release operating unit for carrying out a predetermined operation indicative of that the monitoring has been released if the determining unit determines that the release information inputted by the inputting unit is right.

2. A security device provided with a human body detecting unit for detecting a man to monitor an intruder from the outside, comprising:
a direction specifying unit for specifying the direction in which the man detected by the human body detecting unit accesses;
a direction determining unit for determining whether or not the direction specified by the direction specifying unit agrees a preset direction; and
a reporting unit for making a report if the direction determining unit determines that the direction specified by the direction specifying unit does not agree with the preset direction.

3. A security device according to claim 2, further comprising:
an inputting unit for inputting release information for monitor releasing;
a determining unit for determining whether or not the release information inputted by the input unit is right; and
a releasing unit for releasing the monitoring if the direction determining unit determines that the direction specified by the direction specifying unit agrees with the preset direction and if the determining unit determines that the release information inputted by the input unit is right.

4. A security device according to claim 3, further comprising:
a monitor release operating unit for carrying out a predetermined operation indicative of that the monitoring has been released if the releasing unit releases the monitoring.

5. A autonomous cleaner comprising:
a cabinet formed in a cylindrical shape and closed in the upper face;
a running section which is located within the cabinet and moves the autonomous cleaner in a desired direction;
a cleaning section for cleaning a cleaning plane which is a running plane during movement;
a human body detecting unit for detecting a man; and
a security device provided with the human body detecting unit to monitor an intruder from the outside, including:
a direction specifying unit for specifying the direction in which the man detected by the human body detecting unit accesses;
a direction determining unit for determining whether or not the direction specified by the direction specifying unit agrees a preset direction; and
a reporting unit for making a report if the direction determining unit determines that the direction specified by the direction specifying unit does not agree with the preset direction.
